(19) United States
(12) Patent Application Publication
(10) Pub. No.: US 2012/0009540 A1
(43) Pub. Date: Jan. 12, 2012

(54) LED Tooth Whitening Device and Method of Tooth Whitening Using the Device

(75) Inventor: Nour Kawa, Emeryville, CA (US)

(73) Assignee: GOSMILE, INC., Berkeley, CA (US)

(21) Appl. No.: 13/165,408

(22) Filed: Jun. 21, 2011

Related U.S. Application Data
(60) Provisional application No. 61/357,087, filed on Jun. 21, 2010.

(51) Int. Cl. A61C 17/00

(52) U.S. Cl. 433/29; 433/215; 433/217.1

(57) ABSTRACT

In an embodiment, a tooth whitening device includes a body having at least one LED disposed at an end of the body, and a mouthpiece removably attached to the body adjacent the LED. The mouthpiece can include an insertion end having a shape complimentary to an arch of upper and lower teeth of a user and sized to be received within the mouth of a user. The mouthpiece can include a wall at the insertion end that defines an opening. The wall surrounds buccal surfaces of the upper and lower teeth of the user such that at least a smile zone of the upper and lower teeth of the user is exposed through the opening. Light is transmitted from the LED through the opening to expose at least the smile zone of the upper and lower teeth.

### CROSS-REFERENCE TO RELATED APPLICATION

The benefit under 35 U.S.C. §119(e) of U.S. Provisional Patent Application Ser. No. 61/357,087 filed Jun. 21, 2010, is hereby claimed, and the disclosure thereof is hereby incorporated by reference herein.

### FIELD OF THE INVENTION

The invention relates generally to a tooth whitening device and methods of tooth whitening using the device and, more particularly, to a tooth whitening device that includes a light emitting diode, which exposes the teeth to light and a method of using the device to whitening teeth.

### BRIEF DESCRIPTION OF RELATED TECHNOLOGY

Tooth whitening has become popular with many consumers, as many desire to have a white and bright smile. Conventional tooth whitening generally includes application of a peroxide formulation to effect whitening of the teeth. Conventional light-based whitening devices, which typically emit ultraviolet light and heat, such as from an infrared light source, may be used in combination with the peroxide based whitening composition to accelerate the whitening rate of the composition. Ultraviolet light and infrared light, however, can be hazardous to a user, for example, causing irreversible pulpitis.

### SUMMARY OF THE INVENTION

In one embodiment, a handheld tooth whitening device includes a body having at least one light-emitting diode (LED) disposed at an end of the body, and a mouthpiece removably attached to the body adjacent the LED. The mouthpiece preferably includes an insertion end having a shape complementary to an arch of the upper and lower teeth of a user. The insertion end of the mouthpiece preferably is sized to be received within the mouth of a user. The insertion end of the mouthpiece preferably includes a wall defining an opening, wherein the wall surrounds buccal surfaces of the upper and lower teeth of the user such that at least a smile zone of the upper and lower teeth of the user is exposed through the opening. Light from the LED is transmitted through the opening in the mouthpiece. The mouthpiece preferably is adapted to focus light from the at least one LED onto the buccal surface of the upper and lower teeth to expose at least the smile zone of the upper and lower teeth to the light.

In another embodiment, a method of using the handheld tooth whitening device described above can include placing the insertion end of the mouthpiece into a user's mouth, and illuminating the upper and lower teeth of the user with light emitted from the LED.

The foregoing and other aspects and advantages will become apparent from the following detailed description and drawings.

### BRIEF DESCRIPTION OF THE DRAWINGS

FIG. 1 is a front view of an LED tooth whitening device in accordance with an embodiment of the disclosure;

FIG. 2 is a side view of the LED tooth whitening device of FIG. 1;

FIG. 3 is a back view of the LED tooth whitening device of FIG. 1; and

FIG. 4 is a back view of an LED tooth whitening device in accordance with an embodiment of the disclosure.

### DETAILED DESCRIPTION

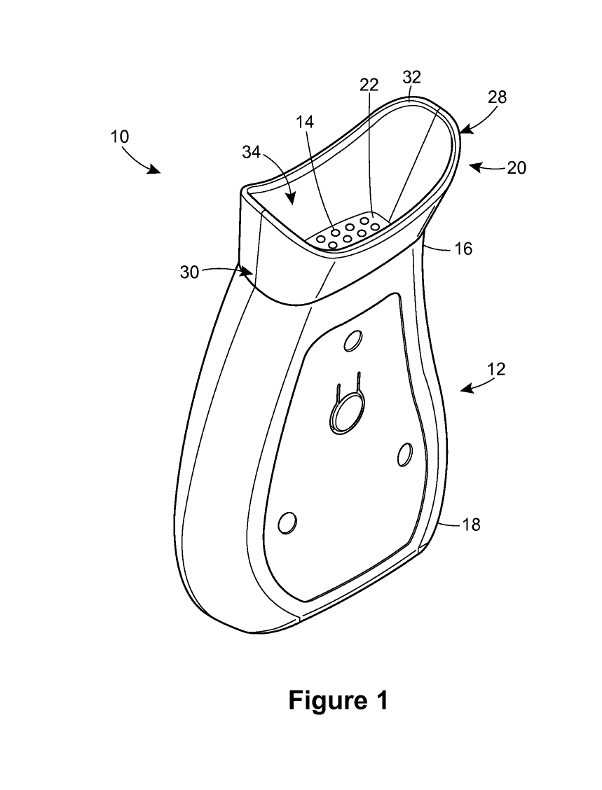

Referring to FIG. 1, in accordance with an embodiment of the disclosure, an LED tooth whitening device generally designated 10 includes a body generally designated 12 having at least one light emitting diode (LED) 14 disposed at an LED end 16 of the body 12 opposite a base end 18. The device 10 further includes a mouthpiece generally designated 20 removably attached to the body 12 adjacent the LED 14.

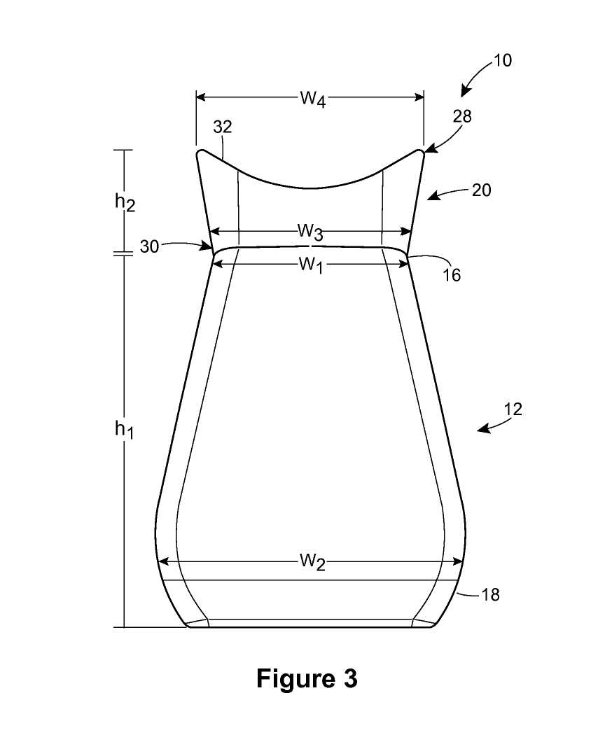

The LED tooth whitening device 10 can be a handheld device 10 adapted to be placed within the mouth of a user and held in place by the user's hand. The body 12 can have any suitable size and shape. For example, the body 12 can be sized and shaped to fit comfortably within a user's hand. For example, as shown in FIGS. 1 and 3, the body 12 can have a tapered shape having an LED end 16, in which the at least one LED 14 is disposed, with a narrower width w₁ than a width w₂ of the base end 18. For example, the LED end 16 can have a width w₁ in a range of about 1 inch to about 3 inches, about 1.5 inches to about 2.5 inches, or about 1 inch to about 2 inches. Other suitable widths w₁ of the LED end 16 include, for example, about 1, 1.2, 1.4, 1.6, 1.8, 2, 2.2, 2.4, 2.6, 2.8, or 3 inches. In one embodiment, the width w₁ of the LED end 16 can be, for example, about 2.05 inches. The width w₂ of the base end 18 can be in a range of about 1 inch to about 5 inches, about 2 inches to about 4 inches, or about 1 inch to about 3 inches. Other suitable widths w₂ for the base end 18 include, for example, about 1, 1.2, 1.4, 1.6, 1.8, 2, 2.2, 2.4, 2.6, 2.8, 3, 3.2, 3.4, 3.6, 3.8, 4, 4.0, 4.2, 4.4, 4.6, 4.8, or 5 inches. In one embodiment, the width w₂ of the base end 18 can be for example, about 3.25 inches.

The body 12 can have a height h₁ suitable to comfortably fit within the hand of the user. For example, the body 12 can have a height h₁, as defined from the base end 18 to the LED end 16 in a range of about 2 inches to about 10 inches, about 4 inches to about 8 inches, or about 4 inches to about 5 inches. Other suitable heights h₁ can include about 1, 2, 3, 4, 5, 6, 7, 8, 9, and 10 inches. In one embodiment, the body 12 has a height h₁ of about 4.025 inches.

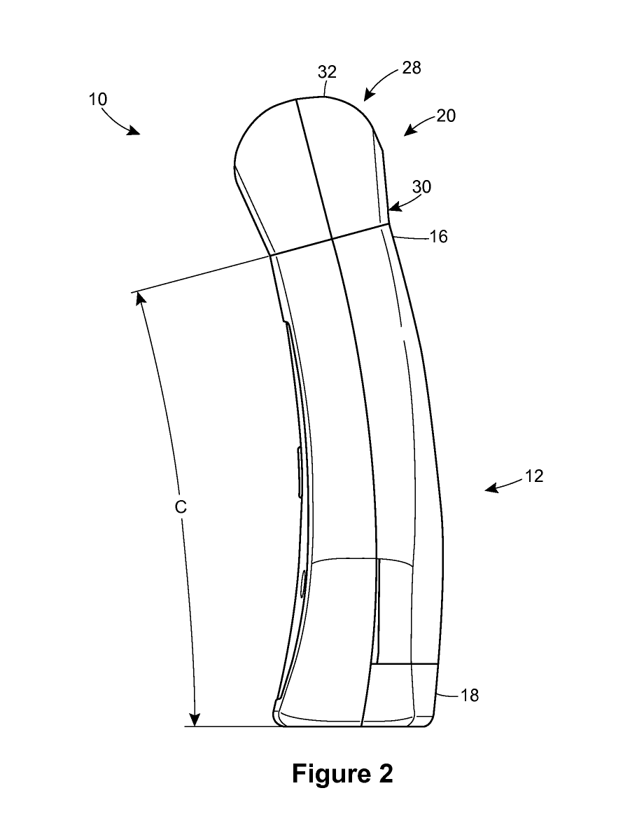

Referring to FIG. 2, the body 12 can be curved to more comfortably fit within a user's hand. For example, the body 12 can have a curvature c in a range of about 0° to about 25°, about 1° to about 10°, about 2° to about 8°, about 4° to about 6°, 5° to about 25°, about 10° to about 20°, or about 12° to about 14°. Other suitable curvatures include about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, or 25°.

At least one LED 14 is disposed in the body 12 at the LED end 16. For example, the LED 14 can be disposed on a circuit board sized to be received in the body 12 at the LED end 16. Any suitable number of LEDs can be included in the whitening device 10. For example, the device 10 can include about 1 to about 20 LEDs, about 5 to about 15 LEDs, or about 7 to about 10 LEDs. Other suitable numbers of LEDs include, for example, about 1, 2, 3, 4, 5, 6, 7, 8, 9, 10, 11, 12, 13, 14, 15, 16, 17, 18, 19, or 20 LEDs. The LEDs can be arranged in any suitable pattern. For example, ten LEDs can be included in the device 10 arranged in two rows of five LEDs each. A transparent protective panel 22 can be disposed over the at least one led 14. Preferably, the LEDs emit white light, which is a mixture of wavelengths of visible light. Other suitable lights sources include blue light (generally having a wavelength in a range of 450 nm to 475 nm). Other types of electromagnetic radiation, for example, outside the visible spectrum can be used in the device 10. For example, the device can include a source of infrared radiation or ultraviolet light.

The LED end 16 is adapted to receive the removably attached mouthpiece 20. The mouthpiece 20 can be removably attached to the body 12 at the LED end 16 in any suitable manner. For example, the LED end 16 and the mouthpiece 20 can include interlocking complimentary structures to removably attach the mouthpiece 20 to the body 12. In one embodiment, the LED end 16 includes a groove (not shown) adapted to receive a ridge (not shown) disposed on the mouthpiece 20.

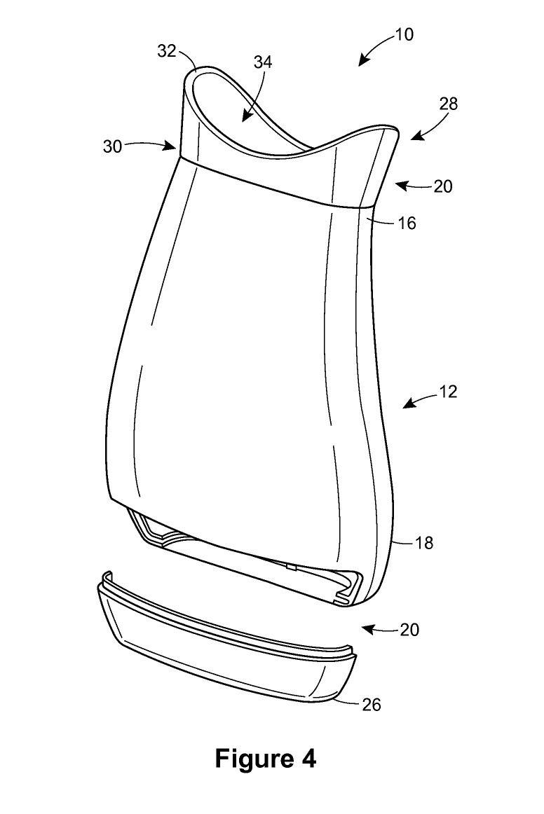

The device 10 can be battery operated. Referring to FIG. 4, the body 12 can further include a battery receiving compartment 24. For example, the battery receiving compartment 24 can be disposed near the base end 18 of the body 12. The base end 18 can include a removably attached end cap 26, which covers a battery (not shown) disposed within the battery compartment 24. The battery compartment 24 can be sized so as to receive any suitable battery type, for example, 3 V lithium battery, an AA, or an AAA battery.

Referring again to FIGS. 1 through 3, the mouthpiece 20 removably attaches to the body 12. Removably attachment of the mouthpiece 20 allows a user to detach and sanitize the mouthpiece 20 without harming the LEDs disposed in the body 12.

The mouthpiece 20 is sized and shaped to fit within the mouth of the user. The mouthpiece 20 has an insertion end generally designated 28 and an attachment end generally designated 30. The attachment end 30 is adapted to be removably attached to the body 12 at the LED end 16. For example, the attachment end 30 can include an interlocking structure (not shown) configured to interlock with an interlocking structure at the LED end 16 of the body 12. Any other suitable attachment mechanism can be used to removably attach the mouthpiece 20 to the body 12. The mouthpiece 20 attaches to the body 12 so as to surround the at least one LED 14 disposed at the LED end 16 of the body 12, such that the LED 14 emits light through an opening 34 defined in the attachment end 30 of the mouthpiece 20. For example, the attachment end 30 of the mouthpiece 20 can surround the transparent protective panel 22 overlying the LED 14 at the LED end 16 of the body 12.

The mouthpiece 20 can have, for example, a width at the attachment end 30 that is substantially the same as the width of the LED end 16 of the body 12. For example, the attachment end 30 can have a width w₃ in a range of about 1 inch to about 3 inches, about 1.5 inches to about 2.5 inches, or about 1 inch to about 2 inches. Other suitable widths w₃ of the attachment end 30 include, for example, about 1, 1.2, 1.4, 1.6, 1.8, 2, 2.2, 2.4, 2.6, 2.8, or 3 inches.

Referring to FIG. 3, the mouthpiece 20 can have a width w₄ that is larger at the insertion end 28 than the width w₃ at the attachment end 30. The mouthpiece 20 can taper continuously outwardly from the attachment end 30 to the insertion end 28. The continuous taper can be designed to adapt the mouthpiece 20 to more comfortably reside within the mouth of the user. For example, the insertion end 28 can be inserted into the user's mouth and the narrowing taper of the mouthpiece 20 can allow a more comfortable surface for the lips of the user to close at least partial and reside on the sides of the mouthpiece 20.

The insertion end 28 can have a width w₄, for example, in a range of about 1 inch to about 5 inches, about 2 inches to about 4 inches, about 1.5 inches to about 2.5 inches, or about 2 inches to about 3 inches. Other suitable widths w₄ include, for example, about 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, or 5 inches. The insertion end 28 can have a shape complementary to the arch of the upper and lower teeth of a user. For example, the insertion end 28 can have a crescent shape. The insertion end 28 is sized to be received within the mouth of a user. The insertion end 28 is defined by an insertion wall 32 that the surrounds the buccal surfaces of the upper and lower teeth of the user. The wall defines an opening 34 through which at least a smile zone of the upper and lower teeth of the user is exposed. As used here, “smile zone” refers to at least the upper eight teeth and lower eight teeth located in the front portion of a user's mouth.

The mouthpiece 20 preferably has a height h₂ in a range of about 0.5 inches to about 3 inches, about 1 inch to about 3 inches, about 0.5 inches to about 1.5 inches, or about 1 to 2 inches. Other suitable heights h₂ include about 0.5, 0.6, 0.7, 0.8, 0.9, 1, 1.2, 1.4, 1.6, 1.8, 2, 2.2, 2.4, 2.6, 2.8, or 3 inches. In one embodiment, the height of the mouthpiece 20 ensures suitable spacing of the LEDs and the teeth to be whitened to enhance the spatial distribution of the light emitted from the LEDs onto at least a smile zone of the upper and lower teeth of the user.

In use, the light from the LED 14 is transmitted through the mouthpiece 20. The mouthpiece 20 can be shaped, for example, as a taper, to focus the light of the LED 14 onto the buccal surface of the upper and lower teeth, such that at least a smile zone of the user's upper and lower teeth is exposed to the light emitted from the LED 14.

The device 10 can further include a timer to alert the user when a predetermined amount of time for whitening exposure has lapsed. The timer can be configured, for example, to automatically shut-off the device 10 when a predetermined amount of time for whitening exposure has lapsed. The device can 10 also include a notification alarm, for example a beeper, configured to sound when the timer expires to alert the use that the whitening exposure time has lapsed.

The device 10 can be used to whiten teeth either alone or in combination with a whitening composition. For example, the light emitted from the device 10 may function to accelerate the whitening rate of a whitening composition. The device 10 can be used to whiten teeth by having a user place the insertion end 28 of the mouthpiece 20 into their mouth, such that the insertion wall 32 surrounds the upper and lower teeth of the user and at least a smile zone of the upper and lower teeth are exposed through the opening 34 in the insertion end 28. Light is then emitted by the LEDs through the mouthpiece 20 and is focused to illuminate at least the smile zone of the user's upper and lower teeth. The device 10 is held in place by the user. For example, the user can hold the device 10 with a hand. The teeth are exposed to the light emitted from the LEDs for a predetermined amount of time to effect whitening of the teeth. When the device 10 is used in combination with a tooth whitening composition, the whitening composition can be applied to the user's teeth before placing the insertion end 28 of the mouthpiece 20 into the user's mouth. The shape of the mouthpiece 20 allows the insertion end 28 of the mouthpiece 20 to reside in the user's mouth without interfering with or rubbing off any of the whitening composition applied to the user's teeth.

In one embodiment, the method of using the device 10 includes exposing the teeth to the light emitted from the at least one led 14 for a time in a range of about 10 minutes to about 60 minutes, about 15 minutes to about 45 minutes, about 20 minutes to about 30 minutes. Other suitable times include about 10, 15, 20, 25, 30, 35, 40, 45, 50, 55, or 60 minutes. The exposure can be performed as a single exposure for the predetermined amount of time. Alternatively, multiple exposures can be performed. For example, a user can expose the teeth to the light using the LED device 10 for three consecutive exposures lasting 10 minutes each. The exposures can be separated by periods of non-exposure lasting any suitable amount of time. For example the periods of non-exposure can last for a time in a range of about 1 minute to about 15 minutes, about 5 minutes to about 10 minutes, or about 4 minutes to about 8 minutes.

Additional aspects and details of the invention will be apparent from the following example, which is intended to be illustrative rather than limiting.

### Example

The effectiveness of an LED whitening device 10 in accordance with the disclosure was studied in connection with use to enhance the whitening effect of a whitening composition. Forty subjects were split into two groups. The subjects of the first group performed tooth whitening by applying a whitening composition and exposing the teeth to a light using the LED whitening device 10. The second group, a control group, used only the whitening composition. All subjects were healthy and had healthy, natural maxillary teeth that were judged to have a Vita shade of A3 or darker. The mean age for the first group was 37.1±16.0, and the mean age for the second group was 36.3±14.4. Each group had a male to female ratio of about 50:50.

The first group exposed their teeth to light using the LED whitening device 10 after application of the whitening composition. The subjects of the first group performed a single exposure that included three consecutive ten minute exposures.

Efficacy was based on human sensory and machine measurements of teeth whiteness using the Vita Shade Score and Colorimeter L* Measurement. It was determined that on average all teeth became statistically significantly whiter after just one treatment using the combination of the whitening composition and the LED device 10 and using the whitening composition alone. Under the Vita Shade Score system, lower scores are lighter colored teeth. A Vita Shade Score ranges from 1 to 16, with 1 representing the lightest color and 16 representing the darkest color. The mean Vita shade improvement of the second group was 3.09 shades (p<0.0001). The mean Vita shade improvement of the first group was 5.65 shades (p<0.0001). These results demonstrate that the use of the LED device 10 enhanced the whitening result by about 50%. The results of the Vita Shade measurements are shown in Table 1.

TABLE 1
Vita Shade Improvement Measurements

| | First Group | Second Group |
|---|---|---|
| | (With LED Device) | (Without LED Device) |
| Before Treatment | 9.85 | 9.85 |
| After Treatment | 4.20 | 5.95 |
| Vita Shade Change | −5.65 | −3.90 |
| Standard Deviation | ±0.9 | ±0.7 |
| Significance | 0.0001 | 0.0001 |

The results as measured using the colorimeter L* machine were similar. Under the L* measurement system, higher L* scores represent lighter colored teeth. The L* scale ranges from 0 to 100, with 0 representing black and 100 representing white. The mean L* improvement of the second group was 7.93 units (p<0.0001), while the mean L* improvement for the first group was 12.11 units (p<0.0001). The results of the L* measurements are shown in Table 2.

TABLE 2
L* Machine Improvement Measurements

| | First Group | Second Group |
|---|---|---|
| | (With LED Device) | (Without LED Device) |
| Before Treatment | 64.57 | 64.63 |
| After Treatment | 76.68 | 72.56 |
| L* Measure Change | 12.11 | 7.93 |
| Standard Deviation | ±1.9 | ±1.6 |
| Significance | 0.0001 | 0.0001 |

Safety of using the whitening device 10 was determined using the Loe and Silness Gingival Index Scoring (Table 3), VAS Sensitivity Index Scoring (Table 4), and through thorough monitoring of the hard and soft tissue oral health of the subjects. There were no ill effects cased by either use of the whitening composition alone or in combination with the LED whitening device 10. There were also no adverse reactions and no tissue change found except for mild reversible blanching/bleaching of the marginal gingival in about 20% of the subjects studied. The results of the Gingival Index Scoring are shown in Table 3. Under the Gingival Index Scoring system 0 represents no inflammation, 1 represents mild inflammation, 2 represents moderate inflammation, and 3 represents severe inflammation. Neither group showed any statistical worsening of gingival condition (p>0.05).

TABLE 3
Loe and Silness Gingival Index Scoring

| | First Group | Second Group |
|---|---|---|
| | (With LED Device) | (Without LED Device) |
| Before Treatment | 1.08 | 1.14 |
| After Treatment | 1.26 | 1.21 |
| Gingival Change | 0.18 | 0.07 |
| Standard Deviation | ±0.2 | ±0.2 |
| Significance | 0.0613 | 0.0625 |

The results of the VAS Sensitivity Index Scoring are shown in Table 4. VAS Sensitivity Index Scoring ranges from 0 to 10, with 0 representing absolutely no sensitivity and 10 representing the most severe sensitivity. Neither group showed any statistical worsening of teeth sensitivity after treatment (p<0.05).

TABLE 4
VAS Sensitivity Index Scoring

| | First Group | Second Group |
|---|---|---|
| | (With LED Device) | (Without LED Device) |
| Before Treatment | 0.25 | 0.20 |
| After Treatment | 0.50 | 0.55 |
| Vita Shade Change | 0.25 | 0.35 |
| Standard Deviation | ±0.4 | ±0.6 |
| Significance | 0.0858 | 0.0924 |

The invention has been described with reference to specific examples, which are intended to be illustrative only and not to be limiting of the invention. It will be apparent to those of ordinary skill in the art that changes, additions, and/or deletions may be made to the disclosed embodiments without departing from the spirit and scope of the invention.

1. A handheld tooth whitening device comprising:
a body having at least one light-emitting diode (LED) disposed at an LED end of the body, and
a mouthpiece removably attached to the body adjacent the LED, the mouthpiece having an insertion end having a shape complementary to an arch of upper and lower teeth of a user, the insertion end of the mouthpiece being sized to be received within the mouth of the user and having a wall defining an opening, wherein the wall surrounds buccal surfaces of the upper and lower teeth of the user such that at least a smile zone of the upper and lower teeth of the user is exposed through the opening,
wherein light from the LED is transmitted through the opening in the mouthpiece, and the mouthpiece is adapted to focus light from the LED onto the buccal surfaces of the upper and lower teeth to expose at least the smile zone of the upper and lower teeth to the light.

2. The device of claim 1, wherein the LED end of the body has a width in a range of about 1 inch to about 3 inches.

3. The device of claim 1, wherein the body has a tapered shape and a width at the LED end of the body is narrower than a width at a base end of the body disposed opposite the LED end.

4. The device of claim 3, wherein the width of the base end of the body is in a range of 1 inch to about 5 inches.

5. The device of claim 1, wherein the body has a height in a range of about 2 inches to about 10 inches.

6. The device of claim 1, wherein the width of the mouthpiece at the insertion end is in a range of about 1 inch to about 5 inches.

7. The device of claim 1, wherein the insertion end of the mouthpiece has a crescent.

8. The device of claim 1, wherein the mouthpiece has a tapered shape and a width at the insertion end of the mouthpiece is greater than a width at an attachment end of the mouthpiece disposed opposite the insertion end.

9. The device of claim 8, wherein the attachment end has a width in a range of about 1 inch to about 3 inches.

10. The device of claim 1, wherein the mouthpiece has a height in a range of about 0.5 inches to about 3 inches.

11. The device of claim 1, wherein the device comprises ten LEDs arranged in two rows of five LEDs in each row.

12. The device of claim 1, wherein the LED emits white light.

13. The device of claim 1, further comprising a timer.

14. The device of claim 12, wherein the timer is adapted to automatically shut off the LED after a predetermined amount of time.

15. The device of claim 1, further comprising a battery compartment disposed in a base end of the body disposed opposite the LED end.

16. The device of claim 1, wherein the mouthpiece comprises an attachment end having a first interlocking structure, the body comprises a base end having a second interlocking structure, and the first and second interlocking structures correspond to removably attach the mouthpiece to the body.

17. The device of claim 1, further comprising a transparent protective panel disposed over the LED.

18. The device of claim 1, wherein the base is curved at an angle in a range of about 0° to about 25°.

19. A method of whitening teeth, comprising
placing the insertion end of the mouthpiece of the device of claim 1 into a user's mouth; and
illuminating at least the smile zone of the upper and lower teeth of the user with light emitted from the at least one LED.

20. The method of claim 19, wherein the upper and lower teeth of the user are illuminated for a time in a range of about 10 minutes to about 60 minutes.

21. The method of claim 19, further comprising applying a whitening composition to the teeth prior to illuminating the smile zone.
